(19) United States
(12) Patent Application Publication
(10) Pub. No.: US 2019/0170499 A1
(43) Pub. Date: Jun. 6, 2019

(54) POSITION DETECTION DEVICE

(71) Applicant: DENSO CORPORATION, Kariya-city (JP)

(72) Inventors: Takasuke ITO, Kariya-city (JP); Yoshiyuki KONO, Kariya-city (JP); Tomoyuki TAKIGUCHI, Kariya-city (JP); Sadahito FUKUMORI, Kariya-city (JP)

(21) Appl. No.: 16/267,646

(22) Filed: Feb. 5, 2019

Related U.S. Application Data
(63) Continuation of application No. PCT/JP2017/029296, filed on Aug. 14, 2017.

(30) Foreign Application Priority Data
Aug. 23, 2016 (JP) 2016-162959
Feb. 3, 2017 (JP) 2017-18250

(51) Int. Cl. G01B 7/30; G01D 5/245; G01D 11/24; G01D 5/14; H01R 43/02

(52) U.S. Cl. CPC G01B 7/30; G01D 5/245; H01R 43/0221; G01D 5/145; H01R 43/0214; G01D 11/245

(57) ABSTRACT

A position detection device is configured to detect a position of a detection target. The position detection device includes: an IC package including a magnetic detection element configured to output a signal that depend on a direction or a strength of an ambient magnetic field, a sealing portion in which the magnetic detection element is sealed, and lead lines, which are projected from the sealing portion and are electrically connected to the magnetic detection elements; terminal lines electrically connectable to the lead lines respectively; and a lead guide placed along the lead lines to restrict positional deviation of the lead lines.

### CROSS REFERENCE TO RELATED APPLICATION

The present application is a continuation application of International Patent Application No. PCT/JP2017/029296 filed on Aug. 14, 2017, which designated the U.S. and claims the benefit of priority from Japanese Patent Applications No. 2016-162959 filed on Aug. 23, 2016 and No. 2017-018250 filed on Feb. 3, 2017. The entire disclosures of all of the above applications are incorporated herein by reference.

### TECHNICAL FIELD

The present disclosure relates to a position detection device.

### BACKGROUND

Conventionally, a position detection device is used for detecting the position of an object such as a rotational axis of a movable body.

### SUMMARY

According to one aspect of the present disclosure, a position detection device includes a detector to detect an intensity relevant to a magnetic field. The detector is connected with lead lines. The lead lines are further coupled to terminal lines respectively.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating an electronic control throttle device to which a position detection device according to a first embodiment of the present disclosure is applied;

FIG. 2 is a schematic view illustrating the position detection device according to the first embodiment of the present disclosure;

FIG. 3 is a partial enlarged view illustrating the position detection device according to the first embodiment of the present disclosure;

FIG. 4 is a diagram seen from the direction of an arrow IV in FIG. 3;

FIG. 5 is a partial enlarged view illustrating a position detection device according to a second embodiment of the present disclosure;

FIG. 6 is a diagram seen from the direction of an arrow VI in FIG. 5;

FIG. 7 is a partial enlarged view illustrating a position detection device according to a third embodiment of the present disclosure; and

FIG. 8 is a diagram seen from the direction of an arrow VIII in FIG. 7.

### DETAILED DESCRIPTION

To begin with, an exemplified configuration of a position detecting device will be described as follows.

The position detection device is configured to detect the position of a detection target. The position detection device includes an IC package. The IC package may include two magnetic detection elements configured to detect variations in a magnetic field caused by movement of the detection target. The IC package is electrically connected with sensor terminals. A connector portion is further provided to enable the sensor terminals to electrically connect to external terminals.

In the position detection device as exemplified, the IC package may have multiple lead lines which are coupled to multiple terminal lines respectively by welding. When the lead lines are welded to the terminal lines, loads such as mechanical loads could be applied to the lead lines.

Conceivably, the lead lines could be thin and may be relatively low in stiffness. Thus, the lead lines may possibly be bent due to application of the loads. In a condition where one lead line as bent is deviated from its specified position, the lead line may make contact with another lead line or another terminal line. Consequently, this contact could possibly result in electrical short circuit.

In consideration of those issues, a position detection device may have a configuration to restrict a short circuit between lead lines of an IC package.

In one example, a position detection device includes an IC package, terminal lines, and a lead guide. The IC package includes lead lines that project from a sealing portion in which a magnetic detection element is sealed. Terminal lines are electrically connected to the lead lines respectively. The lead guide is placed along the lead lines to restrict positional deviation of the lead lines.

Presumably, when the lead lines and the terminal lines are connected electrically, loads could be applied to the lead lines. The lead guide of this example may restrict the lead lines from being deformed and from deviating from those specified positions on the application of the loads. This example therefore could enable to restrict the lead lines and from making contact with unintended components, thereby possibly to restrict occurrence of a short cut in the lead lines.

Embodiments of the present disclosure will be described below with reference to the drawings. Substantially the same components of embodiments are given the same reference numerals and descriptions thereof are omitted.

### First Embodiment

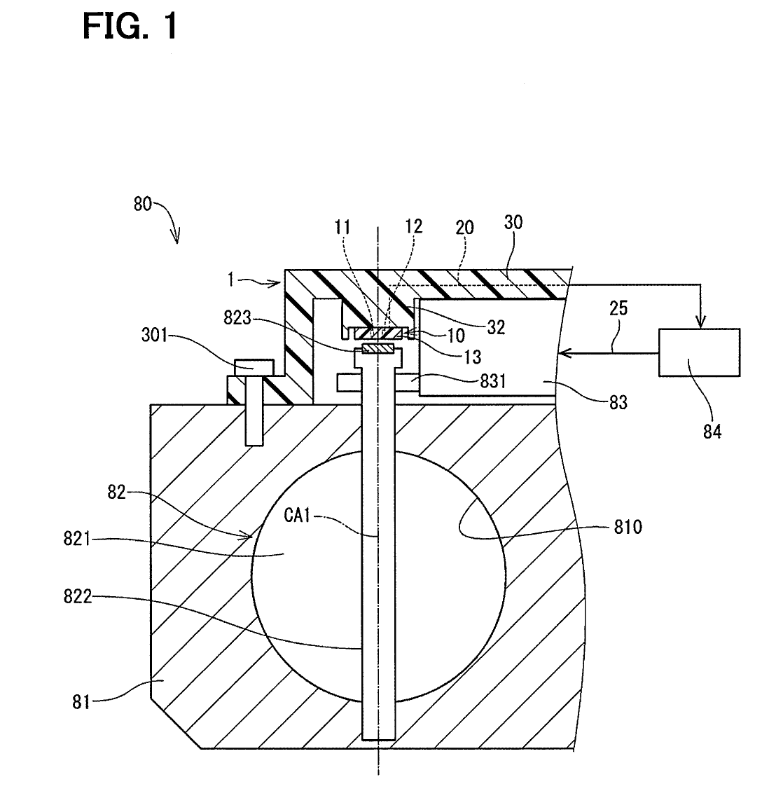

A position detection device according to a first embodiment will be described with reference to FIGS. 1 to 4. A rotation angle detection device 1, which is “the position detection device” according to the first embodiment, is used in an electronic control throttle device 80 that controls the amount of intake air supplied to an engine installed in a vehicle (not illustrated).

First, the structure of the electronic control throttle device 80 will be described. As illustrated in FIG. 1, the electronic control throttle device 80 includes a valve housing 81, a throttle valve 82, a motor 83, the rotation angle detection device 1, an electronic control unit (referred to below as the ECU) 84, and the like.

The valve housing 81 includes an intake air passage 810 through which air is introduced to the engine. The throttle valve 82 is provided in the intake air passage 810.

The throttle valve 82 includes a valve member 821 as “a detection target” and a valve shaft 822.

The valve member 821 is a substantially disk-shaped member having an outer diameter slightly smaller than the inner diameter of the intake air passage 810. The valve member 821 is fixed to the valve shaft 822.

Both sides of the valve shaft 822 are rotationally supported by the valve housing 81. This enables the valve member 821 to rotate about a rotation shaft CA1 of the valve shaft 822 as a rotation shaft. A magnet 823 is provided in an end portion of the valve shaft 822 close to the rotation angle detection device 1. When the valve shaft 822 rotates, a magnetic field in the vicinity of an IC package 10 included in the rotation angle detection device 1 changes.

The motor 83 is accommodated in the rotation angle detection device 1. The motor 83 is coupled to the valve shaft 822 via a coupling member 831. The motor 83 generates a rotational torque to rotate the valve shaft 822. The motor 83 is electrically connected to the ECU 84.

The ECU 84 is a small computer including a CPU as computation unit, a ROM and a RAM as storage unit, input-output unit, and the like. The ECU 84 determines the opening of the throttle valve 82 according to the travel state of the vehicle in which the electronic control throttle device 80 is installed and the operational state of the driver of the vehicle. The ECU 84 outputs electric power to the motor 83 according to the opening of the throttle valve 82. This controls the opening of the throttle valve 82 and adjusts the amount of intake air supplied to the engine.

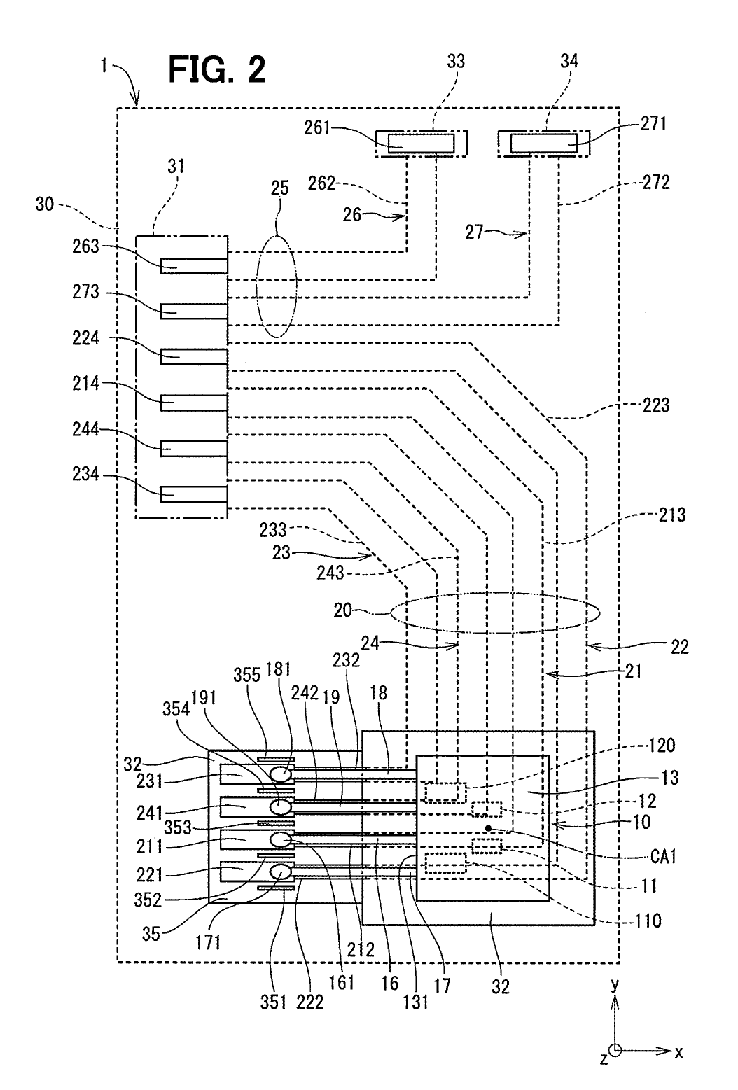

The rotation angle detection device 1 includes the IC package 10, a sensor terminal 20, a motor terminal 25, and a sensor housing 30. The rotation angle detection device 1 is provided in the part of the valve housing 81 close to the end portion of the valve shaft 822 in which the magnet 823 is provided. FIG. 2 represents the sensor housing 30 using a dotted line and schematically illustrates the shapes and the disposition of the IC package 10, the sensor terminal 20, and the motor terminal 25.

The IC package 10 is an IC package referred to as a two-system output type or a two-output type and includes a first magnetic detection element 11, a first signal processing circuit 110, a second magnetic detection element 12, a second signal processing circuit 120, a sealing portion 13, a power supply lead line 16, which is “the lead line”, a first signal lead line 17, which is “the lead line”, a second signal lead line 18, which is “the lead line”, and a ground lead line 19, which is “the lead line”. The IC package 10 is provided in the vicinity of the magnet 823 on the rotation shaft CA1, as illustrated in FIG. 1.

The first magnetic detection element 11 is configured to output a first signal that depends on a first component of the magnetic field formed by the magnet 823 or the strength of the first component. The first magnetic detection element 11 is electrically connected to the power supply lead line 16, the ground lead line 19, and the first signal processing circuit 110.

The first signal processing circuit 110 is electrically connected to the first signal lead line 17. The first signal processing circuit 110 processes the first signal output by the first magnetic detection element 11.

The second magnetic detection element 12 is configured to output a second signal that depends on a second component different from the first component of the magnetic field formed by the magnet 823 or the strength of the second component. The second magnetic detection element 12 is electrically connected to the power supply lead line 16, the ground lead line 19, and the second signal processing circuit 120.

The second signal processing circuit 120 is electrically connected to the second signal lead line 18. The second signal processing circuit 120 processes the second signal output by the second magnetic detection element 12.

The sealing portion 13 is used to seal the first magnetic detection element 11, the first signal processing circuit 110, the second magnetic detection element 12, and the second signal processing circuit 120 and formed in a substantially rectangular parallelepiped.

The power supply lead line 16 is formed so as to project in a direction substantially orthogonal to the rotation shaft CA1 from an end face 131 of the sealing portion 13. The current toward the first magnetic detection element 11 and the second magnetic detection element 12 from a power supply (not illustrated) flows through the power supply lead line 16.

A coordinate plane is set in FIG. 2 to conveniently describe the shapes and disposition of the IC package 10, the sensor terminal 20, and the motor terminal 25. The axis parallel with the direction in which the power supply lead line 16 projects is defined to be the x-axis and the direction in which the power supply lead line 16 projects is defined to be the negative direction of the x-axis. That is, the power supply lead line 16 projects in the negative direction of the x-axis from the end face 131. In addition, the axis orthogonal to the x-axis and the rotation shaft CA1 is defined to be the y-axis. In addition, the axis orthogonal to the x-axis and the y-axis is defined to be the z-axis.

The first signal lead line 17 is formed so as to project in the negative direction of the x-axis from the end face 131 of the sealing portion 13. The first signal output by the first signal processing circuit 110 is configured to be output to the outside through the first signal lead line 17.

The second signal lead line 18 is formed so as to project in the negative direction of the x-axis from the end face 131 of the sealing portion 13. The second signal output by the second signal processing circuit 120 is configured to be output to the outside through the second signal lead line 18.

The ground lead line 19 is formed so as to project in the negative direction of the x-axis from the end face 131 of the sealing portion 13. A current that has flowed through the first magnetic detection element 11 and the second magnetic detection element 12 flows to the ground through the ground lead line 19.

In the IC package 10 according to the first embodiment, the first signal lead line 17, the power supply lead line 16, the ground lead line 19, and the second signal lead line 18 are arranged on the end face 131 in this order so as to project in the negative direction of the x-axis as illustrated in FIG. 2.

The sensor terminal 20 includes a power supply terminal line 21, which is “the terminal line”, a first signal terminal line 22, which is “the terminal line”, a second signal terminal line 23, which is “the terminal”, and a ground terminal line 24, which is “the terminal line”. The sensor terminal 20, which is a member having a relatively large conductivity, is formed so as to extend from the vicinity of the power supply lead line 16 or the like to a connector portion 31 of the sensor housing 30 through the opposite side of the magnet 823 of the IC package 10. The sensor terminal 20 is formed integrally with the sensor housing 30 by insert molding of the sensor housing 30 (see FIG. 1).

The power supply terminal line 21 includes a power supply welding terminal 211, which is “a fixing portion”, a power supply connection portion 212, a power supply insert portion 213, and a power supply connector terminal 214.

The power supply welding terminal 211 is a relatively wide portion provided in a position in which welding to the power supply lead line 16 is enabled. The power supply welding terminal 211 is formed so as to be positioned at the tail end of the power supply terminal line 21 and extend in the positive direction of the x-axis. The side of the power supply welding terminal 211 opposite to the tail end of the power supply terminal line 21 is connected to the power supply connection portion 212.

The power supply connection portion 212 has a width smaller than that of the power supply welding terminal 211. The power supply connection portion 212 is formed so as to extend in the positive direction of the x-axis from the power supply welding terminal 211. The side of the power supply connection portion 212 opposite to the side connected to the power supply welding terminal 211 is connected to the power supply insert portion 213.

The power supply insert portion 213 is inserted into the sensor housing 30. The power supply insert portion 213 is formed so as to extend in the positive direction of the y-axis through the opposite side of the magnet 823 of the IC package 10 and then extend in the negative direction of the x-axis as illustrated in FIG. 2. The side of the power supply insert portion 213 opposite to the side connected to the power supply connection portion 212 is connected to the power supply connector terminal 214.

The power supply connector terminal 214 is positioned in the connector portion 31. The power supply connector terminal 214 is formed so as to be electrically connectable to a power supply (not illustrated) via an external connector (not illustrated). The current toward the first magnetic detection element 11 and the second magnetic detection element 12 from the power supply flows through the power supply terminal line 21.

The first signal terminal line 22 includes a first signal welding terminal 221, which is “the fixing portion”, a first signal connection portion 222, a first signal insert portion 223, and a first signal connector terminal 224.

The first signal welding terminal 221 is a relatively wide portion provided in a position in which welding to the first signal lead line 17 is enabled. The first signal welding terminal 221 is formed so as to be positioned at the tail end of the first signal terminal line 22 and extend in the positive direction of the x-axis. The first signal welding terminal 221 is provided in a position adjacent to the power supply welding terminal 211. The side of the first signal welding terminal 221 opposite to the tail end of the first signal terminal line 22 is connected to the first signal connection portion 222.

The first signal connection portion 222 has a width smaller than that of the first signal welding terminal 221. The first signal connection portion 222 is formed so as to extend in the positive direction of the x-axis from the first signal welding terminal 221. The first signal connection portion 222 is formed so as to have substantially the same length as the power supply connection portion 212. The side of the first signal connection portion 222 opposite to the side connected to the first signal welding terminal 221 is connected to the first signal insert portion 223.

The first signal insert portion 223 is inserted into the sensor housing 30. The first signal insert portion 223 is formed so as to extend in the positive direction of the y-axis through the opposite side of the magnet 823 of the IC package 10 and then extend in the negative direction of the x-axis as illustrated in FIG. 2. The side of the first signal insert portion 223 opposite to the side connected to the first signal connection portion 222 is connected to the first signal connector terminal 224.

The first signal connector terminal 224 is positioned in the connector portion 31. The first signal connector terminal 224 is formed so as to be electrically connectable to the ECU 84 via an external connector. The first signal terminal line 22 outputs the first signal that has been output by the first signal processing circuit 110 to the ECU 84.

The second signal terminal line 23 includes a second signal welding terminal 231, which is “the fixing portion”, a second signal connection portion 232, a second signal insert portion 233, and a second signal connector terminal 234.

The second signal welding terminal 231 is a relatively wide portion provided in a position in which welding to the second signal lead line 18 is enabled. The second signal welding terminal 231 is formed so as to be positioned at the tail end of the second signal terminal line 23 and extend in the positive direction of the x-axis. The second signal welding terminal 231 is provided in a position adjacent to a ground welding terminal 241 of the ground terminal line 24. The side of the second signal welding terminal 231 opposite to the tail end of the second signal terminal line 23 is connected to the second signal connection portion 232.

The second signal connection portion 232 has a width smaller than that of the second signal welding terminal 231. The second signal connection portion 232 is formed so as to extend in the positive direction of the x-axis from the second signal welding terminal 231. The second signal connection portion 232 is formed so as to have substantially the same length as a ground connection portion 242 of the ground terminal line 24. The side of the second signal connection portion 232 opposite to the side connected to the second signal welding terminal 231 is connected to the second signal insert portion 233.

The second signal insert portion 233 is inserted into the sensor housing 30. The second signal insert portion 233 is formed so as to extend in the positive direction of the y-axis through the opposite side of the magnet 823 of the IC package 10 and then extend in the negative direction of the x-axis as illustrated in FIG. 2. The side of the second signal insert portion 233 opposite to the side connected to the second signal connection portion 232 is connected to the second signal connector terminal 234.

The second signal connector terminal 234 is positioned in the connector portion 31. The second signal connector terminal 234 is formed so as to be electrically connectable to the ECU 84 via an external connector. The second signal terminal line 23 outputs the second signal output by the second signal processing circuit 120 to the ECU 84.

The ground terminal line 24 includes the ground welding terminal 241, which is “the fixing portion”, the ground connection portion 242, a ground insert portion 243, and a ground connector terminal 244.

The ground welding terminal 241 is a relatively wide portion provided in a position in which welding to the ground lead line 19 is enabled. The ground welding terminal 241 is formed so as to be positioned at the tail end of the ground terminal line 24 and extend in the positive direction of the x-axis. The ground welding terminal 241 is provided in a position adjacent to the power supply welding terminal 211 and the second signal welding terminal 231. The side of the ground welding terminal 241 opposite to the tail end of the ground terminal line 24 is connected to the ground connection portion 242.

The ground connection portion 242 has a width smaller than that of the ground welding terminal 241. The ground connection portion 242 is formed so as to extend in the positive direction of the x-axis from the ground welding terminal 241. The ground connection portion 242 is formed so as to have substantially the same length as the power supply connection portion 212 and the second signal connection portion 232. The side of the ground connection portion 242 opposite to the side connected to the ground welding terminal 241 is connected to the ground insert portion 243.

The ground insert portion 243 is inserted into the sensor housing 30. The ground insert portion 243 is formed so as to extend in the positive direction of the y-axis through the opposite side of the magnet 823 of the IC package 10 and then extend in the negative direction of the x-axis as illustrated in FIG. 2. The side of the ground insert portion 243 opposite to the side connected to the ground connection portion 242 is connected to the ground connector terminal 244.

The ground connector terminal 244 is positioned in the connector portion 31. The ground connector terminal 244 is formed so as to be electrically connectable to the ground via an external connector. A current that has flowed through the first magnetic detection element 11 and the second magnetic detection element 12 flows to the ground through the ground terminal line 24.

The motor terminal 25 includes two motor terminal lines 26 and 27. The motor terminal lines 26 and 27 include motor connection terminals 261 and 271, motor insert portions 262 and 272, and motor connector terminals 263 and 273, respectively.

The motor connection terminals 261 and 271 are provided in sockets 33 and 34 of the sensor housing 30. The sockets 33 and 34 are formed so as to engage with the motor 83. This enables the motor connection terminals 261 and 271 to be connected to external terminals (not illustrated) of the motor 83. The motor connection terminals 261 and 271 are connected to the motor insert portions 262 and 272.

The motor insert portions 262 and 272 are inserted into the sensor housing 30. The end portions of the motor insert portions 262 and 272 opposite to the sides connected to the motor connection terminals 261 and 271 are connected to the motor connector terminals 263 and 273.

The motor connector terminals 263 and 273 are positioned in the connector portion 31. The motor terminal 25 can supply electric power supplied by the power supply to the motor 83 via the connector portion 31.

The sensor housing 30 is a hollow member formed in a substantially rectangular parallelepiped. The part of the sensor housing 30 close to the valve housing 81 has an opening as illustrated in FIG. 1 so as to accommodate the motor 83 therein. The sensor housing 30 is fixed to the valve housing 81 through a bolt 301 so as to disable relative movement. The sensor housing 30 has a stage 32 on which the IC package 10 can be mounted. Accordingly, the IC package 10 is provided in the vicinity of the magnet 823 as illustrated in FIG. 1. A part of the sensor terminal 20 is inserted into the stage 32.

The sensor housing 30 has a placement table 35 on which the power supply welding terminal 211, the first signal welding terminal 221, the second signal welding terminal 231, and the ground welding terminal 241 are placed. Lead guides 351, 352, 353, 354, and 355, which are “fixing portion side wall bodies”, are provided on the placement table 35. The lead guides 351, 352, 353, 354, and 355 are made of insulating resin material.

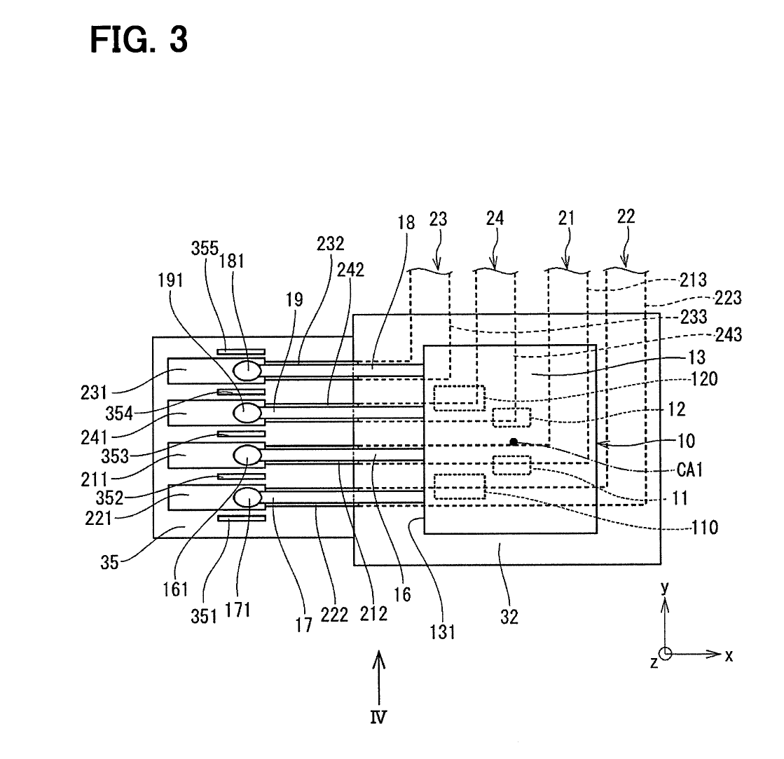

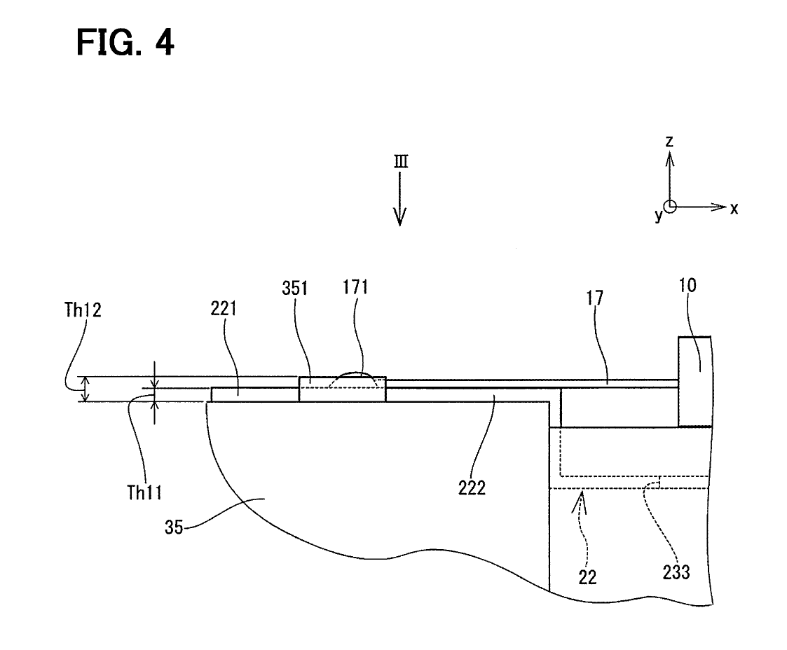

The lead guide 351 is placed along the first signal lead line 17 on the side of the first signal welding terminal 221 positioned in the negative direction of the y-axis. The lead guide 351 is positioned in the vicinity of a welding portion 171 in which the first signal welding terminal 221 is welded to the first signal lead line 17. As illustrated in FIG. 4, which is a partial enlarged view seen from the direction of the arrow IV in FIG. 3, a height Th12 of the lead guide 351 along the z-axis is larger than a height Th11 of the first signal welding terminal 221 along the z-axis.

The lead guide 352 is placed along the first signal lead line 17 and the power supply lead line 16 between the first signal welding terminal 221 and the power supply welding terminal 211. That is, the first signal lead line 17 on the first signal welding terminal 221 is sandwiched between the lead guide 351 and the lead guide 352. The lead guide 352 is positioned in the vicinity of a welding portion 161 in which the power supply welding terminal 211 is welded to the power supply lead line 16 and the welding portion 171. The height of the lead guide 352 along the z-axis is larger than the height of the first signal welding terminal 221 along the z-axis and the height of the power supply welding terminal 211 along the z-axis.

The lead guide 353 is placed along the power supply lead line 16 and the ground lead line 19 between the power supply welding terminal 211 and the ground welding terminal 241. That is, the power supply lead line 16 on the power supply welding terminal 211 is sandwiched between the lead guide 352 and the lead guide 353. The lead guide 353 is positioned in the vicinity of a welding portion 191 in which the ground welding terminal 241 is welded to the ground lead line 19 and the welding portion 171. The height of the lead guide 353 along the z-axis is larger than the height of the power supply welding terminal 211 along the z-axis and the height of the ground welding terminal 241 along the z-axis.

The lead guide 354 is placed along the ground lead line 19 and the second signal lead line 18 between the ground welding terminal 241 and the second signal welding terminal 231. That is, the ground lead line 19 on the ground welding terminal 241 is sandwiched between the lead guide 353 and the lead guide 354. The lead guide 354 is positioned in the vicinity of a welding portion 181 in which the second signal welding terminal 231 is welded to the second signal lead line 18 and the welding portion 191. The height of the lead guide 354 along the z-axis is larger than the height of the ground welding terminal 241 along the z-axis and the height of the second signal welding terminal 231 along the z-axis.

The lead guide 355 is placed along the second signal lead line 18 on the side of the second signal welding terminal 231 positioned in the positive direction of the y-axis. That is, the second signal lead line 18 on the second signal welding terminal 231 is sandwiched between the lead guide 354 and the lead guide 355. The lead guide 355 is positioned in the vicinity of the welding portion 181. The height of the lead guide 355 along the z-axis is larger than the height of the second signal welding terminal 231 along the z-axis.

The rotation angle detection device 1 according to the first embodiment has the lead guides 351, 352, 353, 354, and 355 adjacent to the welding terminals 211, 221, 231, and 241. This enables to restrict the lead lines 16, 17, 18, and 19 from being deformed and deviating from predetermined positions by loads (particularly mechanical loads) during welding when the lead lines 16, 17, 18, and 19 are welded to the terminal lines 21, 22, 23, and 24. Accordingly, the rotation angle detection device 1 enables to restrict a short circuit between the lead lines 16, 17, 18, and 19 and other lead lines or unintended terminal lines because the positional deviation of the lead lines 16, 17, 18, and 19.

In the rotation angle detection device 1, the lead guides 352, 353, and 354 are provided between the lead lines 16, 17, 18, and 19 adjacent to each other. This enables to restrict a short circuit between the lead lines 16, 17, 18, and 19 adjacent to each other due to loads during welding.

### Second Embodiment

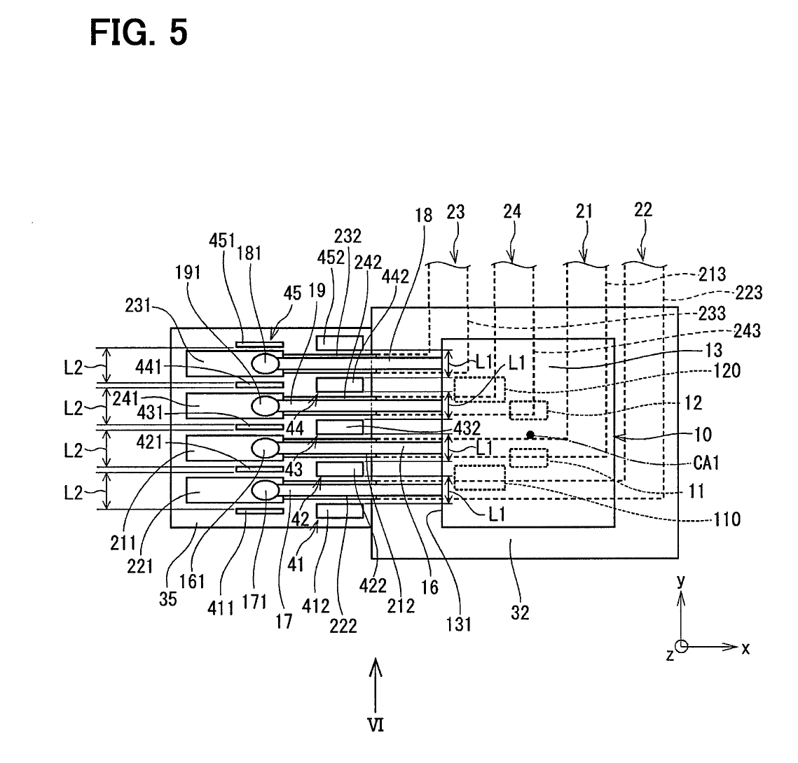

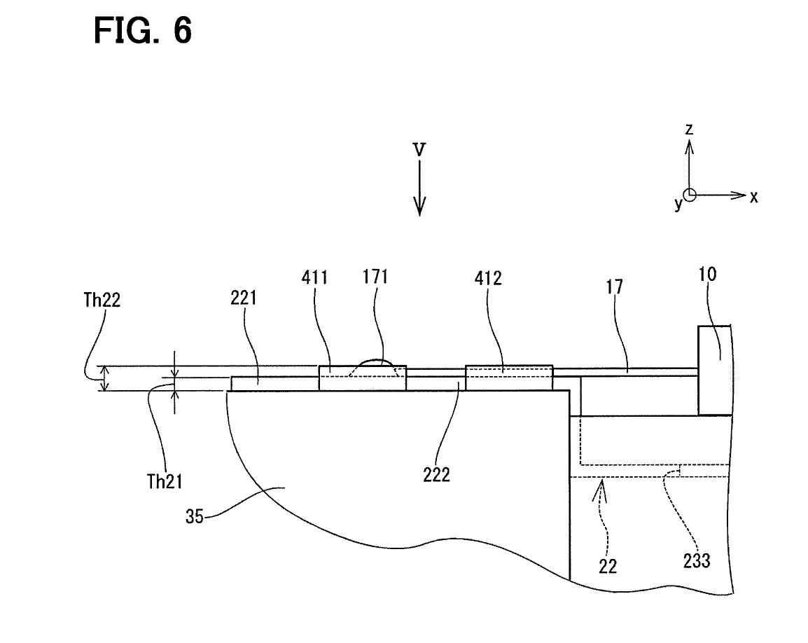

A position detection device according to a second embodiment will be described with reference to FIGS. 5 and 6. The second embodiment is different from the first embodiment in the structure of lead guides.

A partial enlarged view of a rotation angle detection device according to a second embodiment is illustrated in FIG. 5. The rotation angle detection device according to the second embodiment includes an IC package 10, a sensor terminal 20, a motor terminal 25, a sensor housing 30, and lead guides 41, 42, 43, 44, and 45. The lead guides 41, 42, 43, 44, and 45 are made of insulating resin material.

The lead guide 41 has a fixing portion side wall body 411 and a sealing portion side wall body 412. The fixing portion side wall body 411 and the sealing portion side wall body 412 are formed as separate members and provided on a placement table 35.

The fixing portion side wall body 411 is placed along the first signal lead line 17 on the side of the first signal welding terminal 221 positioned in the negative direction of the y-axis. The fixing portion side wall body 411 is positioned in the vicinity of a welding portion 171. As illustrated in FIG. 6, which is a partial enlarged view seen from the direction of the arrow VI in FIG. 5, a height Th22 of the fixing portion side wall body 411 along the z-axis is larger than a height Th21 of the first signal welding terminal 221 along the z-axis.

The sealing portion side wall body 412 is provided in a place, on the side of the first signal lead line 17 positioned in the negative direction of the y-axis, that is closer to a sealing portion 13 than the fixing portion side wall body 411. The height of the sealing portion side wall body 412 along the z-axis is larger than the height Th21 of the first signal connection portion 222 along the z-axis as illustrated in FIG. 6.

The lead guide 42 has a fixing portion side wall body 421 and a sealing portion side wall body 422. The fixing portion side wall body 421 and the sealing portion side wall body 422 are formed as separate members and provided on the placement table 35.

The fixing portion side wall body 421 is placed along the first signal lead line 17 and a power supply lead line 16 between the first signal welding terminal 221 and a power supply welding terminal 211. The fixing portion side wall body 421 is positioned in the vicinity of a welding portion 161 and the welding portion 171. The height of the fixing portion side wall body 421 along the z-axis is larger than the height of the first signal welding terminal 221 along the z-axis and the height of the power supply welding terminal 211 along the z-axis.

The sealing portion side wall body 422 is provided in a place, between the power supply lead line 16 and the first signal lead line 17, that is closer to the sealing portion 13 than the fixing portion side wall body 421. The height of the sealing portion side wall body 422 along the z-axis is larger than the height of the first signal connection portion 222 along the z-axis and the height of a power supply connection portion 212 along the z-axis.

The distance L1 between the sealing portion side wall body 412 and the sealing portion side wall body 422 provided so as to sandwich the first signal connection portion 222 is smaller than the distance L2 between the fixing portion side wall body 411 and the fixing portion side wall body 421 provided so as to sandwich the first signal welding terminal 221.

The lead guide 43 has a fixing portion side wall body 431 and a sealing portion side wall body 432. The fixing portion side wall body 431 and the sealing portion side wall body 432 are formed as separate members and provided on the placement table 35.

The fixing portion side wall body 431 is placed along the power supply lead line 16 and a ground lead line 19 between the power supply welding terminal 211 and a ground welding terminal 241. The fixing portion side wall body 431 is positioned in the vicinity of the welding portion 161 and a welding portion 191. The height of the fixing portion side wall body 431 along the z-axis is larger than the height of the power supply welding terminal 211 along the z-axis and the height of the ground welding terminal 241 along the z-axis direction.

The sealing portion side wall body 432 is provided in a place, between the power supply lead line 16 and the ground lead line 19, that is closer to the sealing portion 13 than the fixing portion side wall body 431. The height of the sealing portion side wall body 432 along the z-axis is larger than the height of the power supply connection portion 212 along the z-axis and the height of a ground connection portion 242 along the z-axis direction.

The distance L1 between the sealing portion side wall body 422 and the sealing portion side wall body 432 provided so as to sandwich the power supply connection portion 212 is smaller than the distance L2 between the fixing portion side wall body 421 and the fixing portion side wall body 431 provided so as to sandwich the power supply welding terminal 211.

The lead guide 44 has a fixing portion side wall body 441 and a sealing portion side wall body 442. The fixing portion side wall body 441 and the sealing portion side wall body 442 are formed as separate members and provided on the placement table 35.

The fixing portion side wall body 441 is placed along the ground lead line 19 and a second signal lead line 18 between the ground welding terminal 241 and a second signal welding terminal 231. The fixing portion side wall body 441 is positioned in the vicinity of the welding portion 191 and a welding portion 181. The height of the fixing portion side wall body 441 along the z-axis direction is larger than the height of the ground welding terminal 241 along the z-axis direction and the height of the second signal welding terminal 231 along the z-axis direction.

The sealing portion side wall body 442 is provided in a place, between the ground lead line 19 and the second signal lead line 18, that is closer to the sealing portion 13 than the fixing portion side wall body 441. The height of the sealing portion side wall body 442 along the z-axis direction is larger than the height of the ground connection portion 242 along the z-axis and the height of a second signal connection portion 232 along the z-axis direction.

The distance L1 between the sealing portion side wall body 432 and the sealing portion side wall body 442 so as to sandwich the ground connection portion 242 is smaller than the distance L2 between the fixing portion side wall body 431 and the fixing portion side wall body 441 provided so as to sandwich the ground welding terminal 241.

The lead guide 45 has a fixing portion side wall body 451 and a sealing portion side wall body 452. The fixing portion side wall body 451 and the sealing portion side wall body 452 are formed as separate members and provided on the placement table 35.

The fixing portion side wall body 451 is placed along the second signal lead line 18 on the side of the second signal welding terminal 231 positioned in the positive direction of the y-axis. The fixing portion side wall body 451 is positioned in the vicinity of the welding portion 181. The height of the fixing portion side wall body 451 along the z-axis is larger than the height of the second signal welding terminal 231 along the z-axis direction.

The sealing portion side wall body 452 is provided in a place, on the side of the second signal lead line 18 positioned in the positive direction of the y-axis, that is closer to the sealing portion 13 than the fixing portion side wall body 451. The height of the sealing portion side wall body 452 along the z-axis is larger than the height of the second signal connection portion 232 along the z-axis.

The distance L1 between the sealing portion side wall body 442 and the sealing portion side wall body 452 so as to sandwich the second signal connection portion 232 is smaller than the distance L2 between the fixing portion side wall body 441 and the fixing portion side wall body 451 provided so as to sandwich the second signal welding terminal 231.

In the rotation angle detection device according to the second embodiment, the lead guides 41, 42, 43, 44, and 45 are provided in the vicinity of the sealing portion 13 from which the lead lines 16, 17, 18, and 19 project. This enables to restrict the deformation of the lead lines 16, 17, 18, and 19 due to loads during welding even in the vicinity of the sealing portion 13. Accordingly, the second embodiment obtains the same effects as the first embodiment.

In addition, in the rotation angle detection device according to the second embodiment, the lead guides 41, 42, 43, 44, and 45 have the fixing portion side wall bodies 411, 421, 431, 441, and 451 and the sealing portion side wall bodies 412, 422, 432, 442, and 452, respectively. The distance L1 between the sealing portion side wall bodies 412, 422, 432, 442, and 452 adjacent to each other is smaller than the distance L2 between the fixing portion side wall bodies 411, 421, 431, 441, and 451 adjacent to each other. This can further restrict deviation from predetermined positions due to the deformation of the lead lines 16, 17, 18, and 19 in the vicinity of the sealing portion 13. Accordingly, a short circuit caused by electrical contact between the lead lines 16, 17, 18, and 19 and other lead lines or unintended terminal lines can be surely restricted.

### Third Embodiment

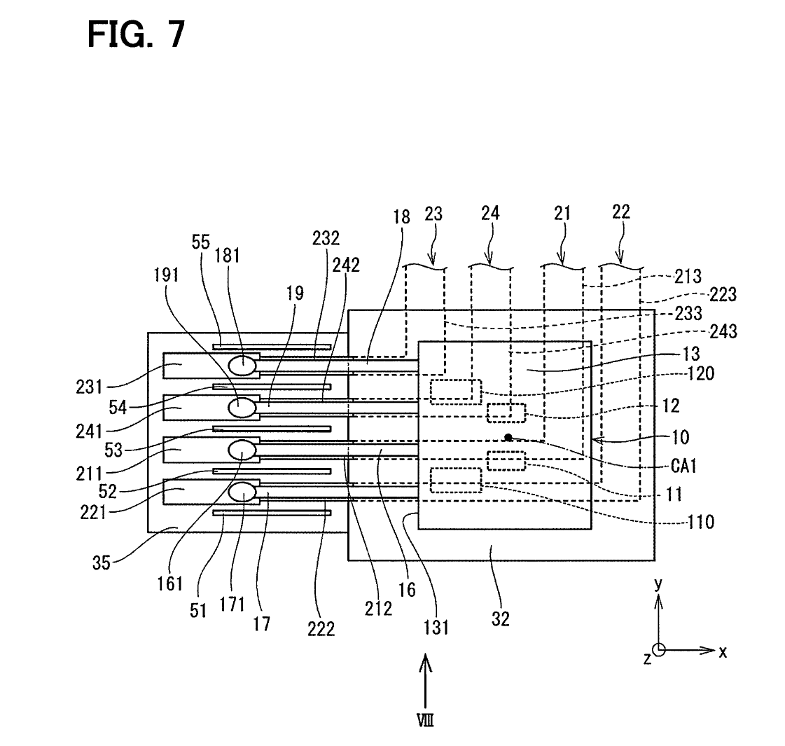

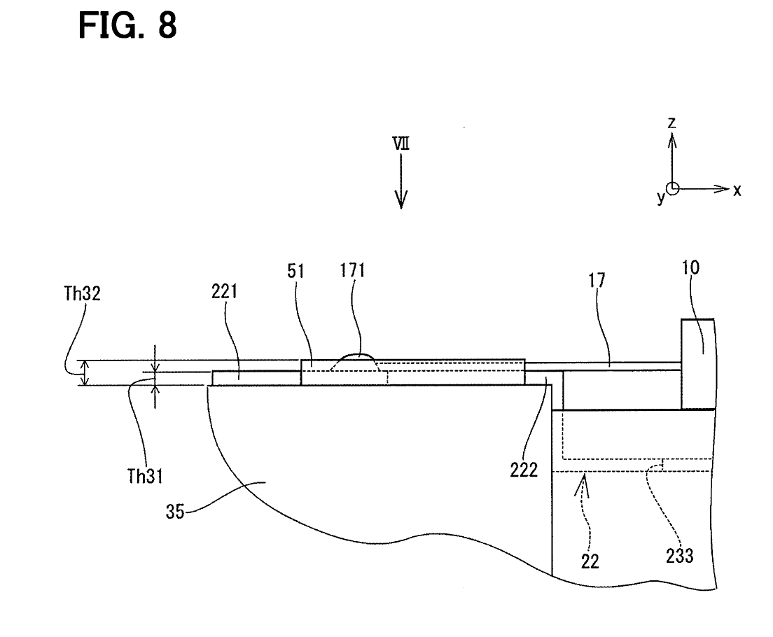

A position detection device according to a third embodiment will be described with reference to FIGS. 7 and 8. The third embodiment is different from the first embodiment in the shapes of lead guides.

A partial enlarged view of a rotation angle detection device according to the third embodiment is illustrated in FIG. 7. The rotation angle detection device according to the third embodiment includes an IC package 10, a sensor terminal 20, a motor terminal 25, a sensor housing 30, and lead guides 51, 52, 53, 54, and 55. The lead guides 51, 52, 53, 54, and 55 are made of insulating resin material.

The lead guide 51 is formed so as to extend from the side of a first signal welding terminal 221 positioned in the negative direction of the y-axis to the vicinity of a sealing portion 13 on the side of a first signal lead line 17 positioned in the negative direction of the y-axis. That is, the lead guide 51 is formed so as to extend closer to the vicinity of the sealing portion 13 than the first signal welding terminal 221 as illustrated in FIG. 7. As illustrated in FIG. 8, which is a partial enlarged view seen from the direction of an arrow VIII in FIG. 7, the height of the lead guide 51 along the z-axis direction is larger than the height of the first signal welding terminal 221 along the z-axis direction and the height of a first signal connection portion 222 along the z-axis direction.

The lead guide 52 is formed so as to extend from a part between the first signal welding terminal 221 and a power supply welding terminal 211 to the vicinity of the sealing portion 13 between the first signal lead line 17 and a power supply lead line 16. That is, the lead guide 52 is formed so as to extend closer to the vicinity of the sealing portion 13 than the first signal welding terminal 221 and the power supply welding terminal 211 as illustrated in FIG. 7. Accordingly, the first signal lead line 17 is sandwiched between the lead guide 51 and the lead guide 52. The height of the lead guide 52 along the z-axis direction is larger than the height of the first signal welding terminal 221 along the z-axis direction, the height of the first signal connection portion 222 along the z-axis direction, the height of the power supply welding terminal 211 along the z-axis direction, and the height of a power supply connection portion 212 along the z-axis direction.

The lead guide 53 is formed so as to extend from a part between the power supply welding terminal 211 and a ground welding terminal 241 to the vicinity of the sealing portion 13 between the power supply lead line 16 and a ground lead line 19. That is, the lead guide 53 is formed so as to extend closer to the vicinity of the sealing portion 13 than the power supply welding terminal 211 and the ground welding terminal 241 as illustrated in FIG. 7. Accordingly, the power supply lead line 16 is sandwiched between the lead guide 52 and the lead guide 53. The height of the lead guide 53 along the z-axis direction is larger than the height of a power supply welding terminal 211 along the z-axis direction, the height of the power supply connection portion 212 along the z-axis direction, the height of the ground welding terminal 241 along the z-axis, and the height of a ground connection portion 242 along the z-axis direction.

The lead guide 54 is formed so as to extend from a part between the ground welding terminal 241 and a second signal welding terminal 231 to the vicinity of the sealing portion 13 between the ground lead line 19 and a second signal lead line 18. That is, the lead guide 54 is formed so as to extend closer to the vicinity of the sealing portion 13 than the ground welding terminal 241 and the second signal welding terminal 231 as illustrated in FIG. 7. Accordingly, the ground lead line 19 is sandwiched between the lead guide 53 and the lead guide 54. The height of the lead guide 54 along the z-axis direction is larger than the height of the ground welding terminal 241 along the z-axis direction, the height of the ground connection portion 242 along the z-axis direction, the height of the second signal welding terminal 231 along the z-axis direction, and a height of the second signal connection portion 232 along the z-axis direction.

The lead guide 55 is formed so as to extend from the side of the second signal welding terminal 231 positioned in the positive direction of the y-axis to the vicinity of the sealing portion 13 on the side of the second signal lead line 18 positioned in the negative direction of the y-axis. That is, the lead guide 55 is formed so as to extend closer to the vicinity of the sealing portion 13 than the second signal welding terminal 231 as illustrated in FIG. 7. Accordingly, the second signal lead line 18 is sandwiched between the lead guide 54 and the lead guide 55. The height of the lead guide 55 along the z-axis direction is larger than the height of the second signal welding terminal 231 along the z-axis direction and the height of the second signal connection portion 232 along the z-axis direction.

In the rotation angle detection device according to the third embodiment, the lead guides 51, 52, 53, 54, and 55 are formed so as to extend closer to the sealing portion than the welding terminals. Accordingly, the third embodiment enables to restrict deviation from predetermined positions caused by the deformation of the lead lines 16, 17, 18, and 19 due to loads during welding even in the vicinity of the sealing portion 13. Accordingly, the third embodiment obtains the same effects as the first embodiment.

In addition, in the rotation angle detection device according to the third embodiment, the lead guides are continuously provided from the welding terminals adjacent thereto to the vicinity of the sealing portion 13. This can surely restrict the positional deviation due to the deformation of the entire lead lines 16, 17, 18, and 19.

### Other Embodiments

In the embodiment described above, the position detection device is applied to the electronic control throttle device that controls the amount of intake air supplied to the engine installed in the vehicle. However, the field to which the position detection device is applied is not limited to these examples.

In the embodiment described above, the power supply welding terminal, the first signal welding terminal, the second signal welding terminal, and the ground welding terminal are provided adjacently to each other on the placement table. However, the power supply welding terminal, the first signal welding terminal, the second signal welding terminal, and the ground welding terminal do not need to be provided adjacently to each other.

In the embodiments described above, the lead lines are fixed to the terminal lines by welding. However, the method of fixing the lead lines to the terminal lines to disable relative movement is not limited to these examples. Coupling may be performed by soldering or conductive adhesive. In addition, the welding may be resistance welding or laser welding.

In the embodiments described above, the IC package has four lead lines. The number of lead lines only needs to be two or more.

In the embodiments described above, the sensor terminal is formed so that one end portions connected to the lead lines are substantially parallel with the other end portions positioned in the connector portion, as illustrated in FIG. 2. However, the shape of the sensor terminal is not limited to these examples.

In the embodiments described above, the position detection device has the motor terminal capable of supplying electric power to the motor. However, the motor terminal may be absent.

In the embodiments described above, the IC package is a two-system output type having two magnetic detection elements. However, the IC package may have only one magnetic detection element or three or more magnetic detection elements.

In the embodiments described above, the IC package has the first signal processing circuit and the second signal processing circuit. However, the IC package may have neither the first signal processing circuit nor the second signal processing circuit. In addition, in the IC package, the first magnetic detection element is provided separately from the first signal processing circuit or the second magnetic detection element is provided separately from the second signal processing circuit. The first magnetic detection element may be integrated with the first signal processing circuit or the second magnetic detection element may be integrated with the second signal processing circuit.

The magnetic detection elements according to the embodiments described above may be magnetic detection elements such as hall elements or MR elements that only need to output signals that depends on a component of a magnetic field or the strength of the component.

In the second embodiment, the height of the fixing portion side wall bodies is the same as that of the sealing portion side wall bodies. However, the height of the fixing portion side wall bodies does not need to be the same as that of the sealing portion side wall bodies.

The present disclosure is not limited to these embodiments and may be practiced in various forms without departing from the spirit of the present disclosure.

While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

1. A position detection device configured to detect a position of a detection target, comprising:
an IC package including
a magnetic detection element configured to output a signal that depends on a direction or a strength of an ambient magnetic field,
a sealing portion in which the magnetic detection element is sealed, and
lead lines projected from the sealing portion and electrically connected to the magnetic detection element;
terminal lines electrically connectable to the lead lines, respectively; and
a lead guide placed along the lead lines to restrict positional deviation of the lead lines.

2. The position detection device according to claim 1, wherein
the lead guide is provided between adjacent two of the lead lines.

3. The position detection device according to claim 1, wherein
the lead guide includes a fixing portion side wall body placed along fixing portions of the terminal lines to which the lead lines are fixed.

4. The position detection device according to claim 3, wherein
the lead guide further includes a sealing portion side wall body provided closer to the sealing portion than the fixing portion side wall body.

5. The position detection device according to claim 4, wherein
a distance between two adjacent sealing portion side wall bodies, which are included in the sealing portion side wall body and are provided to sandwich one of the lead lines, is less than a distance between two adjacent fixing portion side wall bodies, which are included in the fixing portion side wall body and are provided to sandwich the one of the lead lines.

6. The position detection device according to claim 1, wherein
the lead guide extends closer to the sealing portion than fixing portions of the terminal lines to which the lead lines are fixed.
